(19) United States
(12) Patent Application Publication
(10) Pub. No.: US 2006/0097883 A1
(43) Pub. Date: May 11, 2006

(54) Lamar's alert, deterrent, distress, alarm device! the state of needing immediate help; to prevent, alleviate, alert, and deter; abductions, kidnappings, rape, assault, and any other wickedness

(76) Inventor: Dennis Lamar, Fort Madison, IA (US)

Correspondence Address: Dennis Lamar, 31 Ave. G, P.O. Box 316, Fort Madison, IA, 52627, US

(21) Appl. No.: 10/972,999

(22) Filed: Oct. 26, 2004

(51) Int. Cl. G08B 13/00; G08B 3/10

(52) U.S. Cl. 340/574; 340/384.4; 340/384.73

(57) ABSTRACT

A new and useful utility alarm device manufactured with an electronic sound transducer for the specific purpose to emit a loud and continuous/repeated warning sound for impending danger when activated.

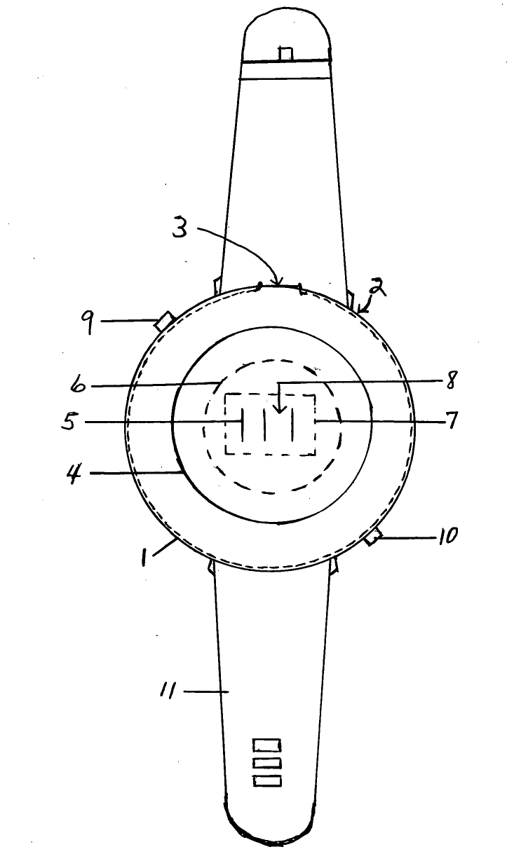

### CROSS-REFERENCE TO RELATED APPLICATIONS

A Disclosure Document Deposit Request was filed on Nov. 14, 2002 and the document number is 521521.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention relates to a manufactured alarm device.

Abduction and kidnapping of children in public places, around school play grounds, and their homes have been brought to public awareness and are of great concern to parents. Also rape, muggings, assaults and robberies, have been rampant on joggers, college campus students, late night workers to and from work and on every day people.

An activated distress alarm will enable children and others to call attention to dangerous actions by strangers, kidnappers abductioners, muggers, robbers, rapist, and any other harmful person.

The subject matter of the claimed invention is a new and useful utility alarm device to be manufactured.

### BRIEF SUMMARY OF THE INVENTION

Lamar's alert, deterrent, distress alarm device to be constructed to have an Electronic Sound Transducer to emit a loud continuous/repeated warning sound of impending danger. To be worn on the wrist or around neck of children who are most vulnerable to abduction while in places where abductions and kidnappings may occur. Also to be worn on the wrist or around the neck or hand held by teenagers, and adults, who may be facing impending danger. The distress alarm is activated by pressing two times a Red activation button The distress alarm will be loud enough to attract attention from persons within the area and beyond. The distress alarm is de-activated by pressing three times a Black de-activation button. The object of the invention is an alarm to deter.

### BRIEF DESCRIPTION OF THE DRAWINGS

Drawing number one: A circular wristband alarm device with a case (1) and a case back (2), a hinged cover (3), a face plate (4), slits (5) constructed into face plate, Electronic Sound Transducer (6), integrated circuit board (7), alkaline or lithium battery pack (8), a red activation button (9), a black de-activation button (10), a optional band or strap (11).

### DETAILED DESCRIPTION OF THE INVENTION

This invention is a new and useful manufactured alarm device comprising of a case and a case back and said case constructed with a hinged cover and within the case an electronic sound transducer and when activated to emit a loud and continuous/repeated warning sound for impending danger.

The specific purpose of Lamar's Alarm device is to enable the endangered child, teenage or adult to activate a loud distress alarm. The alarm sounds are programed into a integrated circuit-board, and the alarm sounds are emitted by an electronic sound transducer and the alarm device powered by an alkaline or lithium battery pack. Activation of the alarm is by pressing two times a red activation button and de-activation of the alarm is by pressing three times a black de-activation button.

The process of making this new, useful invention, (manufactured alarm device) is similar to the process of making the electronic or digital watches, that are on market, with similar construction, materials used and parts, But a big difference between them in purpose and function. A electronic watch sole purpose is to tell time, a timepiece, other features were added, such as month/date/day/, and alarms such as a countdown alarm, hourly alarm, and daily alarm. The sole purpose and only purpose for these alarms constructed within the case are to sound an alarm at a desired time to alert the wearer the time of day or night, (only a timepiece alarm and not an alarm for impending danger).

My invention, the manufactured alarm device is very different in function and purpose. My invention does not serve as a time piece, nor does it have features like month/date/day, nor any type of timepiece alarms such as countdown, hourly or daily.

My invention is solely an alarm device constructed with an electronic sound transducer and when activated to emit a continuous/repeated loud warning sound for impending danger.

The preferred embodiments, the process of making this manufactured alarm device, as shown in the drawing is a case (1) and said case constructed with a hinged cover (3) both made of metal and or plastic, a case back (2) made of metal and or plastic, a face plate (4) made of metal or plastic, slits (5) constructed vertical into the metal or plastic face plate above the electronic sound transducer to allow the sounds from the electronic sound transducer to flow out from the slits, an electronic sound transducer (6) constructed of metal and 1 to 1½ inches in diameter which will be constructed/and placed into said case, a integrated circuit board (7) constructed similar as in electronic or digital watches, a alkaline or lithium battery pack (8) to provide power for operation of alarm device, one red activation button (9) to be pressed two times to activate the alarm and the button to be constructed and similar as those in digital watches, one black de-activation button (10) to be pressed three times to cease/stop the alarm sound and the button to be constructed and similar as those in digital watches, a optional band or strap (11) constructed of leather, or hard rubber or plastic or vinyl or metal to be constructed/attached to the manufactured alarm device.

The constructed alarm device to be constructed to be water resistance, as similar to digital wrist watches. The purpose of the constructed hinged cover is for the hinged cover to protect the face plate and to prevent water, dust and dirt from entering into the constructed slits made into the metal or plastic face plate. The hinged cover to be constructed in the same shape/form as the case and constructed on the case, affixed on the center and upper most part of the case, the hinged cover to be lifted upward off the case & face plate and pushed downward onto the case & face plate. Several high-pitched programmed sounds in the 5,000 hz to 20,000 hz range at 85 db to 120 db are preferred.

These alarm sounds to be programmed into the integrated circuit-board. These sounds are to be continuous/repeated until de-activated. The two buttons, Red and Black to be set and programmed to enable two presses for the Red button for activation and three presses for the Black button for de-activation.

[T]he constructed alarm device is capable of other embodiments and of being practiced or being carried out in various ways. It is to be understood that this invention is not limited in its application to the details of construction and the arrangements of components set forth in this detailed description or illustrated in the drawing. This invention is solely an alarm device for impending danger and not a toy device nor a timepiece device.

What I claim as my invention is a new and useful manufactured alarm device to be constructed to have a case and a case back and said case constructed with a hinged cover and within the case, an electronic sound transducer and when activated by a red activation button, when pressed two times, emit a loud continuous/repeated warning sound for impending danger, with a loud enough distress alarm sound to alert others in public places, around school playgrounds, around home, in and near parks, on school and college campuses and any where the child, teenager, student, jogger, or adult who is being abducted, kidnaped, mugged, assaulted, robbed, raped or threatened by danger or harm, and a black de-activation button, when pressed three times, to cease/stop the warning sound for impending danger:

1. A alarm device comprising;
a case, including a case back,
a hinged cover, said hinged cover constructed and affixed on and in the center and upper most part of said case,
a electronic sound transducer constructed within said case,
a face plate, including constructed slits into said face plate, said slits constructed vertical to allow sounds to flow from said face plate from said electronic sound transducer,
a integrated circuit-board within said case, including programmed optional alarm sounds within said integrated circuit-board, within said case,
a red activation button constructed within said case, said red activation button to be set and programmed to be pressed two times to activate alarm sound within said case,
a black de-activation button constructed within said case, said black de-activation button to be set and programmed to be pressed three times to cease/stop alarm sound within said case,
a alkaline or lithium battery pack within said case for powering said alarm device,
a optional band or strap attached to the said case of said alarm device.

2. A alarm device consisting essentially of:
a case, including a hinged cover and a case back each made of metal or plastic said case, including hinged cover and case back to be made water resistance constructed to prevent water, or dirt or dust from entering into said alarm,
a electronic sound transducer constructed 1 to 1½ inches in diameter made of metal,
a face plate made of metal or plastic including constructed slits made vertical into face plate,
a integrated circuit board manufactured as similar in electronic watches, enabling the said integrated circuit to be programed with optional sounds in the 5,000 hz to 20,000 hz range at 85 db to 120 db,
a red activation button constructed with metal or plastic as similar as those in digital watches,
a black de-activation button constructed with metal or plastic as similar as those in digital watches,
a alkaline or lithium battery pack manufactured,
a optional band or strap constructed of leather or rubber or plastic or vinyl or metal.
